(19) United States
(12) Patent Application Publication
(10) Pub. No.: US 2026/0261895 A1
(43) Pub. Date: Sep. 3, 2026

(54) INITIAL ACQUISITION OPERATIONS FOR A CUSTOMER PREMISES EQUIPMENT

(71) Applicant: QUALCOMM Incorporated, San Diego, CA (US)

(72) Inventors: Jun ZHU, San Diego, CA (US); Ruhua HE, San Diego, CA (US); Rahul MALIK, San Diego, CA (US)

(21) Appl. No.: 19/067,452

(22) Filed: Feb. 28, 2025

(51) Int. Cl. H04W 24/10; H04W 36/08; H04W 76/15

(52) U.S. Cl. CPC H04W 24/10; H04W 36/085; H04W 76/15

(57) ABSTRACT

Various aspects of the present disclosure generally relate to wireless communication. In some aspects, a customer premises equipment (CPE) may measure one or more channels using multiple candidate CPE settings, resulting in multiple sets of measurement results. The CPE may store the multiple sets of measurement results in a data structure. The CPE may identify, via the data structure, a first set of measurement results, of the multiple sets of measurement results, that is associated a highest signal-strength metric. The CPE may transmit, based at least in part on identifying the first set of measurement results, a message associated with an initial acquisition operation using a first candidate CPE setting, of the multiple candidate CPE settings, that is associated with the first set of measurement results. Numerous other aspects are described.

### FIELD OF THE DISCLOSURE

Aspects of the present disclosure generally relate to wireless communication and specifically relate to techniques, apparatuses, and methods associated with initial acquisition operations for a customer premises equipment.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a customer premises equipment (CPE) may communicate with a network node. A CPE may be a device located at an end-user's site that provides connectivity to a telecommunication network (e.g., via the network node). In some examples, a CPE may be associated with a fixed wireless access device, such as a 5G-enabled router, modem, or gateway, among other examples. In some examples, the CPE may perform initial acquisition operations with the network node, such as for a purpose of entering a connected mode in a wireless communication network, among other examples.

### SUMMARY

The systems, methods, and devices of this disclosure each have several innovative aspects, no single one of which is solely responsible for the desirable attributes disclosed herein.

Some aspects described herein relate to a method of wireless communication performed by a customer premises equipment (CPE). The method may include measuring one or more channels using multiple candidate CPE settings, resulting in multiple sets of measurement results. The method may include storing the multiple sets of measurement results in a data structure. The method may include identifying, via the data structure, a first set of measurement results, of the multiple sets of measurement results, that is associated a highest signal-strength metric. The method may include transmitting, based at least in part on identifying the first set of measurement results, a message associated with an initial acquisition operation using a first candidate CPE setting, of the multiple candidate CPE settings, that is associated with the first set of measurement results.

Some aspects described herein relate to a CPE. The CPE may include a processing system. The processing system may include one or more processors and one or more code-storing memories coupled with the one or more processors. The processing system may be configured to cause the CPE to measure one or more channels using multiple candidate CPE settings, resulting in multiple sets of measurement results. The processing system may be configured to cause the CPE to store the multiple sets of measurement results in a data structure. The processing system may be configured to cause the CPE to identify, via the data structure, a first set of measurement results, of the multiple sets of measurement results, that is associated a highest signal-strength metric. The processing system may be configured to cause the CPE to transmit, based at least in part on the identification of the first set of measurement results, a message associated with an initial acquisition operation using a first candidate CPE setting, of the multiple candidate CPE settings, that is associated with the first set of measurement results.

Some aspects described herein relate to a non-transitory computer-readable medium that stores a set of instructions for wireless communication by a CPE. The set of instructions, when executed by one or more processors of the CPE, may cause the CPE to measure one or more channels using multiple candidate CPE settings, resulting in multiple sets of measurement results. The set of instructions, when executed by one or more processors of the CPE, may cause the CPE to store the multiple sets of measurement results in a data structure. The set of instructions, when executed by one or more processors of the CPE, may cause the CPE to identify, via the data structure, a first set of measurement results, of the multiple sets of measurement results, that is associated a highest signal-strength metric. The set of instructions, when executed by one or more processors of the CPE, may cause the CPE to transmit, based at least in part on identifying the first set of measurement results, a message associated with an initial acquisition operation using a first candidate CPE setting, of the multiple candidate CPE settings, that is associated with the first set of measurement results.

Some aspects described herein relate to an apparatus for wireless communication. The apparatus may include means for measuring one or more channels using multiple candidate settings, resulting in multiple sets of measurement results. The apparatus may include means for storing the multiple sets of measurement results in a data structure. The apparatus may include means for identifying, via the data structure, a first set of measurement results, of the multiple sets of measurement results, that is associated a highest signal-strength metric. The apparatus may include means for transmitting, based at least in part on identifying the first set of measurement results, a message associated with an initial acquisition operation using a first candidate setting, of the multiple candidate settings, that is associated with the first set of measurement results.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a random access procedure.

FIG. 4 is a diagram illustrating an example of a four-step random access procedure.

FIG. 5 is a diagram illustrating an example associated with a customer premises equipment (CPE).

FIG. 6 is a diagram of an example associated with initial acquisition operations for a CPE.

FIG. 7 is a diagram illustrating an example associated with a fingerprinting operation for a CPE.

FIG. 8 is a diagram illustrating an example process performed, for example, at a CPE or an apparatus of a CPE.

FIG. 9 is a diagram of an example apparatus for wireless communication.

### DETAILED DESCRIPTION

In some wireless communication systems, a user equipment (UE) may be implemented as a customer premises equipment (CPE) that acts as an intermediary device or an interface device between a service provider network (e.g., via a network node) and a UE (e.g., a mobile phone, a tablet, a desktop computer, a smart watch, or an Internet of Things (IoT) device). Some example CPEs may include a modem, a router, a gateway, a switch, a repeater, a fixed wireless access (FWA) device, or an adapter, among other examples. In some aspects, a CPE may include a reflector, a lens, a mechanical rotator or actuator, or similar components used to increase an array gain or an equivalent isotropic radiated power (EIRP) of an antenna array associated with the CPE. For example, a reflector may increase an effective aperture size of an antenna array by focusing a wireless signal transmitted or received by the antenna array in a manner that concentrates the energy or signal power of the wireless signal, and the CPE may have a mechanical displacement capability to rotate or reposition the antenna panel or the reflector.

In certain CPEs, such as parabolic reflector CPEs, a millimeter wave (mmWave) module may be located at a focal point of the reflector, and a radiating surface of the antenna panel may face a reflecting surface of the reflector. The mmWave module may use a boresight beam associated with the antenna panel for generating a mmWave beam to communicate with a network node. The CPE may additionally use an azimuth-axis motor (e.g., a motor controlling movement in a horizontal plane, such as by rotating the antenna panel or reflector about a vertical axis) or an elevation-axis motor (e.g., a motor controlling movement in a vertical plane, such as by rotating the antenna panel or the reflector about a horizontal axis) for positioning the mmWave beam or for performing a beam scan associated with the CPE. In this regard, mechanical movements of the antenna panel or reflector may replace an electronic beam scan used in a conventional phased array CPE or UE.

In some examples, switching between beams in a phased array CPE may occur at a slot-level timeframe or even a symbol-level timeframe. On the other hand, switching between beams by repositioning CPE elements using mechanical motors may occur at a much longer timeframe. Accordingly, switching between beams at a parabolic reflector CPE or a similar CPE may be too slow to comply with upper layer timelines for mobility, among other examples. In such examples, a CPE (e.g., a parabolic reflector CPE) and a network node may be unable to establish an optimal beam pair during an initial acquisition operation, resulting in degraded communication channels, high latency, low throughput, and a high incidence of communication errors, thus leading to high computing, power, and network resource consumption for correcting communication errors.

Various aspects relate generally to improved initial acquisition operations for a CPE. Some aspects more specifically relate to a fingerprinting operation for a CPE in order to determine optimal CPE settings (e.g., elevation or azimuth settings) to be used during an initial acquisition operation. In some aspects, a CPE (e.g., a parabolic reflector CPE, among other examples) may measure one or more channels using multiple candidate CPE settings (e.g., multiple azimuth and elevation combinations), resulting in multiple sets of measurement results, and the CPE may store the multiple sets of a measurement results in a data structure (sometimes referred to herein as a fingerprinting database). In some aspects, due to a smaller field of view of the CPE relative to a phased array device or because mechanical steering over a large angular coverage may be substantially slower than electronic beam switching at a phased array device, the CPE may perform the fingerprinting operation in a manner that is asynchronous to a protocol timeline, such as by disabling a data communication capability of the CPE during the fingerprinting operation. Following the fingerprinting operation, the CPE may identify, via the data structure (e.g., the fingerprinting database), a set of measurement results that are associated with a highest signal-strength metric, and may use a corresponding CPE setting (e.g., a corresponding azimuth or elevation setting) to attempt initial acquisition (e.g., for transmitting a message associated with an initial acquisition operation).

Particular aspects of the subject matter described in this disclosure can be implemented to realize one or more of the following potential advantages. In some examples, the described techniques can be used to enable communication between the CPE and a network node using an optimal beam pair, resulting in improved communication channels and thus reduced latency and increased throughput in a wireless communication network. In some other examples, the described techniques can be used to improve initial acquisition operations associated with a CPE and a network node (such as by performing an initial acquisition procedure using a beam associated with a highest signal strength metric) and thus reduce communication errors between the CPE and the network node, resulting in a reduction in computing, power, and network resource consumption otherwise required for correcting communication errors.

5G New Radio (NR) may support enhanced mobile broadband (eMBB) access, IoT networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

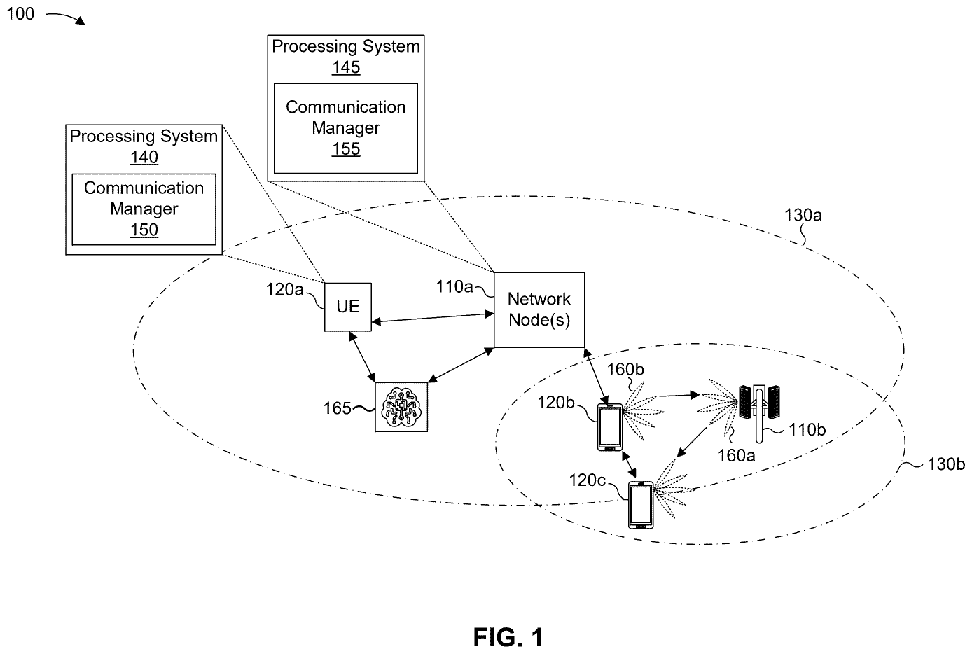

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a CPE, a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, or otherwise increase efficiency of the cell switch.

In some aspects, the UE 120 may correspond to a CPE, and the UE 120 may include a communication manager 150. As described in more detail elsewhere herein, the communication manager 150 may measure one or more channels using multiple candidate CPE settings, resulting in multiple sets of measurement results; store the multiple sets of measurement results in a data structure; identify, via the data structure, a first set of measurement results, of the multiple sets of measurement results, that is associated a highest signal-strength metric; and transmit, based at least in part on identifying the first set of measurement results, a message associated with an initial acquisition operation using a first candidate CPE setting, of the multiple candidate CPE settings, that is associated with the first set of measurement results. Additionally, or alternatively, the communication manager 150 may perform one or more other operations described herein.

In some aspects, the network node 110 may include a communication manager 155. As described in more detail elsewhere herein, the communication manager 155 may receive, from a CPE, a message associated with an initial acquisition operation, wherein the message is received via a CPE transmit beam that is associated with a first candidate CPE setting, of multiple candidate CPE settings, that is associated with a first set of measurement results, and wherein the first set of measurement results is a set of measurement results, of multiple sets of measurement results stored in a data structure at the CPE, that is associated a highest signal-strength metric. Additionally, or alternatively, the communication manager 155 may perform one or more other operations described herein.

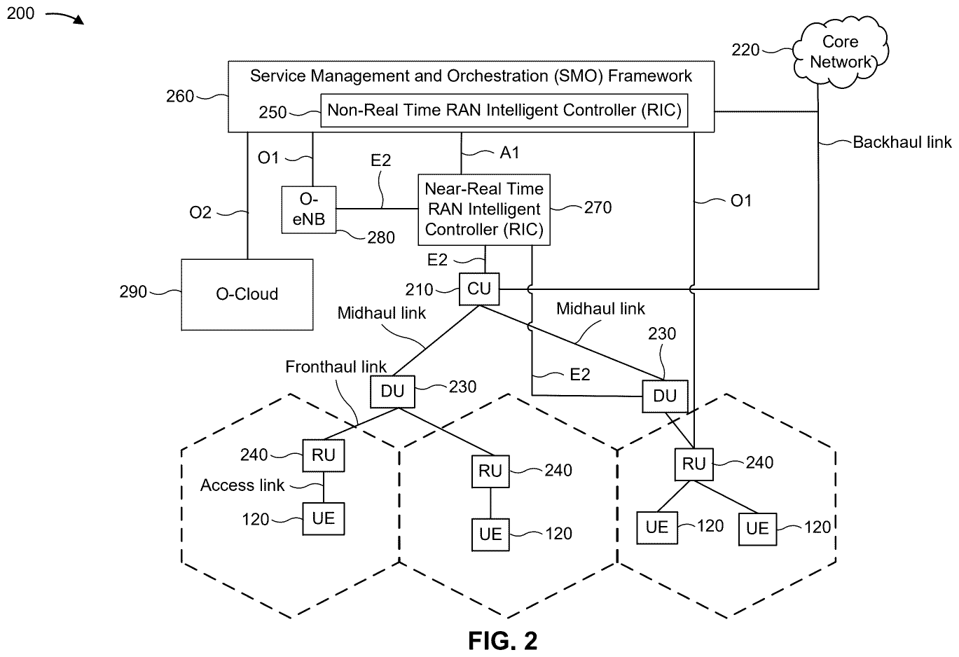

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

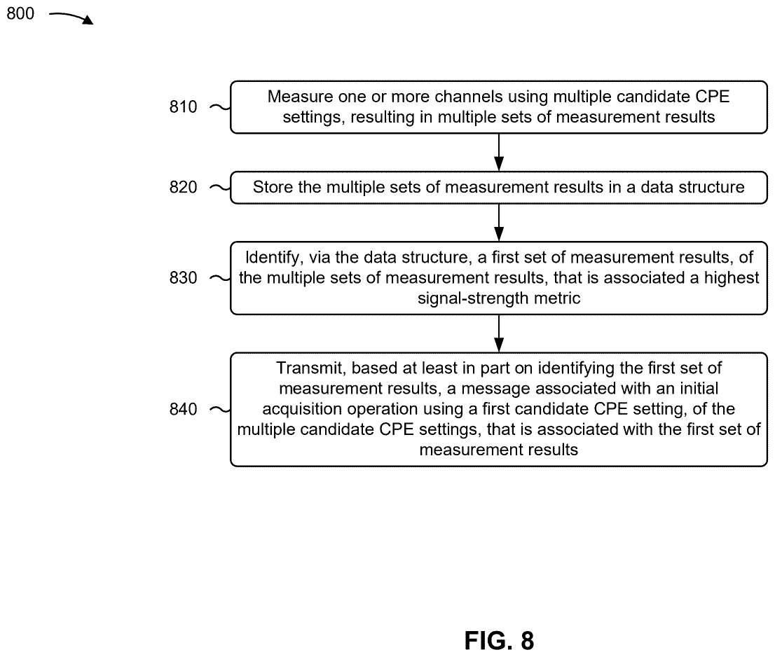

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with initial acquisition operations for a CPE, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, or other processes as described herein (alone or in conjunction with one or more other processors). In some aspects, the CPE described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, or other processes as described herein. In some examples, executing instructions may include running the instructions, converting the instructions, compiling the instructions, or interpreting the instructions, among other examples.

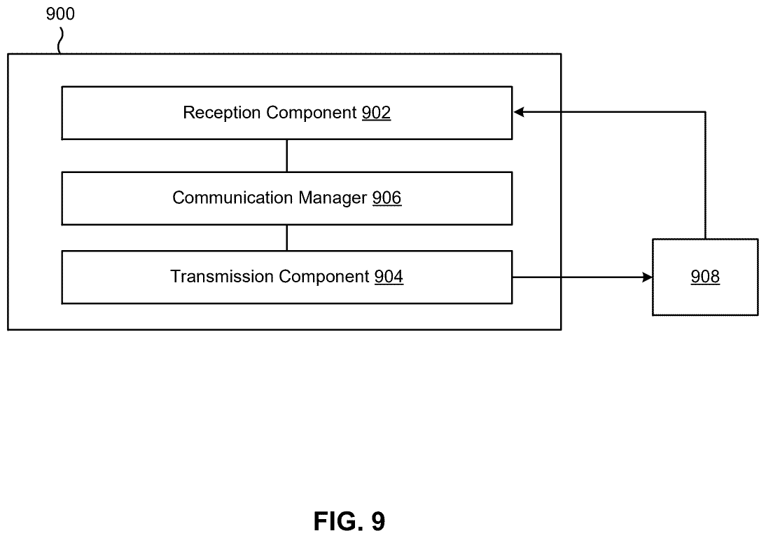

In some aspects, the UE 120 (which, in some aspects, may correspond to a CPE) includes means for measuring one or more channels using multiple candidate settings, resulting in multiple sets of measurement results; means for storing the multiple sets of measurement results in a data structure; means for identifying, via the data structure, a first set of measurement results, of the multiple sets of measurement results, that is associated a highest signal-strength metric; or means for transmitting, based at least in part on identifying the first set of measurement results, a message associated with an initial acquisition operation using a first candidate setting, of the multiple candidate settings, that is associated with the first set of measurement results. In some aspects, the means for the UE 120 (e.g., CPE) to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

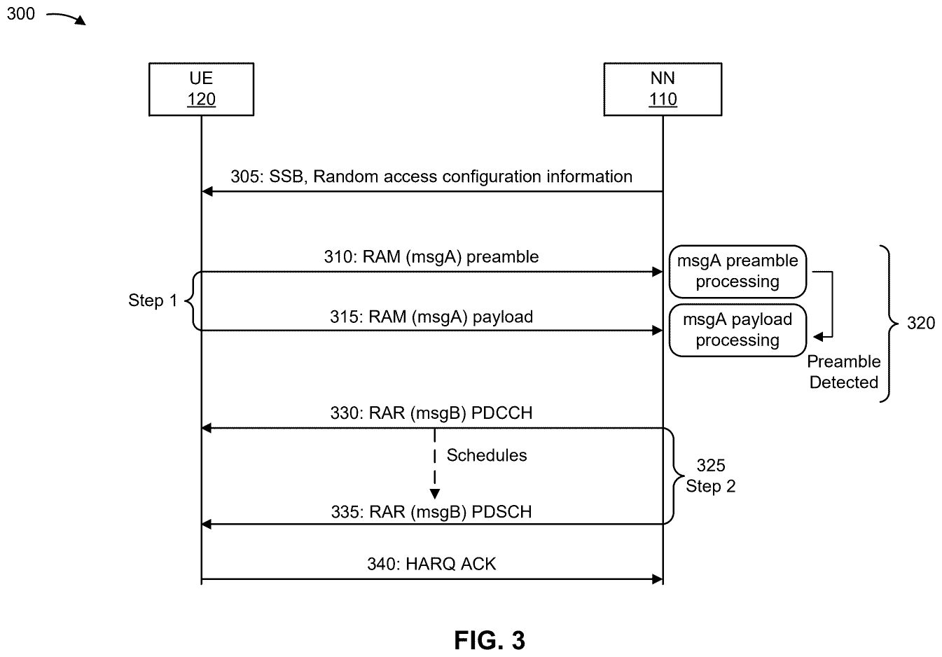

FIG. 3 is a diagram illustrating an example 300 of a random access procedure. In some examples, a UE 120 may perform an initial acquisition operation (sometimes referred to herein as an “InitACQ” operation) with a network node 110. “Initial acquisition operation” refers to a process by which a UE 120 discovers or synchronizes with a network node 110 before establishing a connection, thereby enabling communication between the UE 120 and the network node 110. An initial acquisition operation may be associated with a UE 120 performing a cell search step (e.g., scanning for synchronization signals to detect available cells), performing a time or frequency synchronization step (e.g., synchronizing with the detected cell's timing and carrier frequency), preforming a system information acquisition step (e.g., decoding broadcast system information to proceed with a connection), or performing a random access procedure step (e.g., initiating an access request to establish communication with the network node 110). As shown in FIG. 3, a network node 110 and a UE 120 may communicate with one another to perform a two-step random access procedure, which may be associated with an initial acquisition operation.

More particularly, as shown by reference number 305, the network node 110 may transmit, and the UE 120 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a random access channel (RACH) procedure, such as for contention-free random access. The random access configuration information may include one or more parameters to be used in the two-step random access procedure, such as one or more parameters for transmitting a random access message (RAM) or receiving a random access response (RAR) to the RAM.

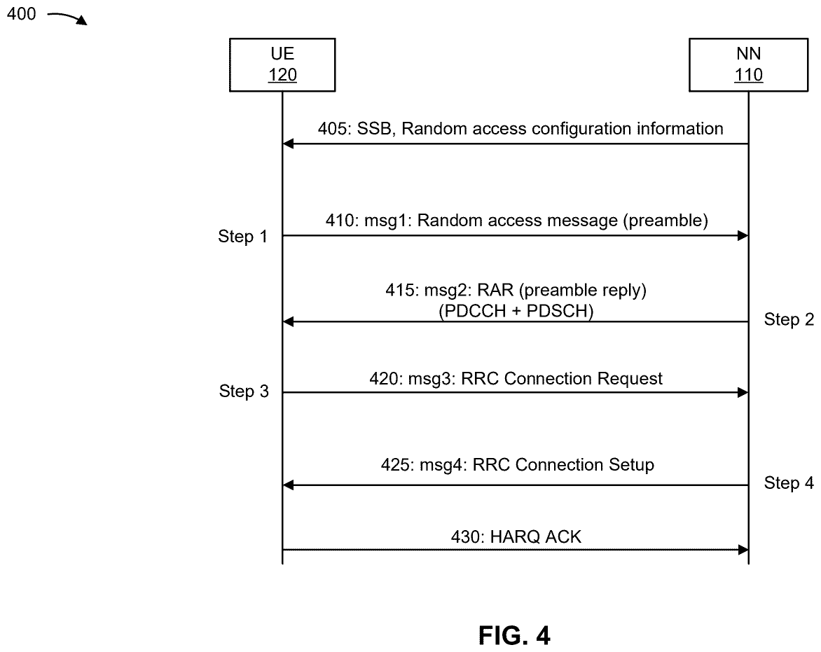

As shown by reference number 310, the UE 120 may transmit, and the network node 110 may receive, a RAM preamble. As shown by reference number 315, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below in connection with FIG. 4. For example, the RAM preamble may include some or all contents of message 1 (e.g., a PRACH preamble), and the RAM payload may include some or all contents of message 3 (e.g., a UE identifier, UCI, or a PUSCH transmission).

As shown by reference number 320, the network node 110 may receive the RAM preamble transmitted by the UE 120. If the network node 110 successfully receives and decodes the RAM preamble, the network node 110 may then receive and decode the RAM payload.

As shown by reference number 325, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure, described in more detail below in connection with FIG. 4. For example, the RAR message may include the detected PRACH preamble identifier, the detected UE identifier, a timing advance value, or contention resolution information.

As shown by reference number 330, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 335, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. As shown by reference number 340, if the UE 120 successfully receives the RAR, the UE 120 may transmit a HARQ ACK.

In some other examples, a random access procedure may be associated with a four-step random access procedure. Aspects of a four-step random access procedure are described in more detail below in connection with FIG. 4.

As indicated above, FIG. 3 is provided as an example. Other examples may differ from what is described with regard to FIG. 3.

FIG. 4 is a diagram illustrating an example 400 of a four-step random access procedure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 430, if the UE 120 successfully receives the RRC connection setup message, the UE 120 may transmit a HARQ ACK.

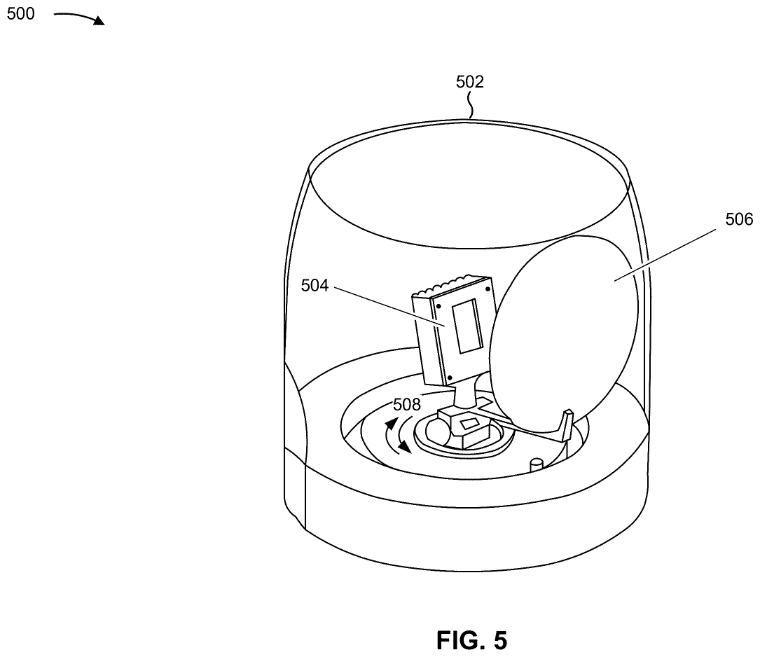

In some examples, a UE 120 performing an initial acquisition operation, such as an initial acquisition operation associated with the two-step random access procedure described above in connection with FIG. 3 or the four-step random access procedure described above in connection with FIG. 4, among other examples, may be a CPE. Aspects of certain CPEs are described in more detail below in connection with FIG. 5.

As indicated above, FIG. 4 is provided as an example. Other examples may differ from what is described with regard to FIG. 4.

FIG. 5 is a diagram illustrating an example 500 associated with a CPE. In some examples, a UE 120 may be implemented as a CPE that acts as an intermediary device or an interface device between a service provider network (e.g., via a network node 110) and another UE (e.g., a mobile phone, a tablet, a desktop computer, a smart watch, or an IoT). Some example CPEs may include a modem, a router, a gateway, a switch, a repeater, an FWA device, or an adapter, among other examples.

In some aspects, a CPE may include a reflector, a lens, a mechanical rotator or actuator, or similar components used to increase an array gain or an EIRP of an antenna array associated with the CPE. For example, as shown by FIG. 5, a CPE 502 may include an antenna panel 504 (e.g., an antenna array) and a reflector 506. In some aspects, the reflector 506 may increase an effective aperture size of the antenna array by focusing a wireless signal transmitted or received by the antenna array in a manner that concentrates the energy or signal power of the wireless signal. One such example of a reflector includes a Cassegrain reflector that uses a primary concave mirror and a secondary convex mirror to focus a wireless signal.

Additionally, or alternatively, the reflector 506 may be a parabolic-shaped reflector, and thus the CPE 502 may be referred to as a parabolic reflector CPE. A parabolic reflector CPE is an innovative, low-cost alternative to a conventional active element phased array CPE conforming to the 3GPP FR2 power class 1 (PC1) requirements, that may be based on passive collimation to tradeoff fast mobility for higher EIRP or effective isotropic sensitivity (EIS) in a thermally efficient design (e.g., due to fewer active elements than an active element phased array CPE, among other reasons). Although not shown in example 500, other types of reflectors or CPEs may be utilized without departing from the scope of the disclosure, such a parabolic cylindrical reflector CPE (e.g., a CPE in which the reflector is at least partially cylindrically shaped), a parabolic cylindrical lens CPE (e.g., a CPE that uses a parabolically shaped lens as a refractor to focus a wireless signal), or a similar CPE associated with a suitable passive collimation technique used to reflect or refract, and thus focus, a communication beam.

As shown by reference number 508, the CPE 502 may also include a mechanical displacement capability to rotate or reposition the antenna panel 504 or the reflector 506. For instance, the CPE 502 may rotate the antenna panel 504 or the reflector 506 to improve a signal quality (e.g., increase a received power level), such as by rotating the antenna panel 504 or the reflector 506 to a location that is within a line-of-sight (LoS) of a device that communicates with the CPE 502 using wireless signals, such as a network node 110 or a UE 120. In some aspects, the CPE 502 may iteratively rotate or move components (e.g., the antenna panel or the reflector) based at least in part on the CPE changing locations. The use of the antenna panel 504 in combination with the reflector 506 may reduce power consumption or a thermal overhead of the CPE 502 relative to another CPE that uses a large antenna array, at least through the use of fewer antenna elements.

For a parabolic reflector CPE or a similar CPE, a mmWave module may be located at a focal point of the reflector 506, and a radiating surface of the antenna panel 504 may face a reflecting surface of the reflector 506. The mmWave module may use a boresight beam associated with the antenna panel 504 for generating a mmWave beam to communicate with a network node 110, may use mechanical motion of the various components, such as by using an azimuth-axis motor (e.g., a motor controlling movement in a horizontal plane, such as by rotating the antenna panel 504 or reflector 506 about a vertical axis) or an elevation-axis motor (e.g., a motor controlling movement in a vertical plane, such as by rotating the antenna panel 504 or the reflector 506 about a horizontal axis), to position the mmWave beam or perform a beam scan associated with the CPE 502. In this regard, mechanical movements of the antenna panel 504 or the reflector 506 (e.g., via the azimuth-axis motor or the elevation-axis motor) may replace an electronic beam scan used in a conventional phased array CPE or UE 120, in order to determine a best position or beam for data transfer.

In some examples, an electronic beam switch (e.g., a beam switch associated with a phased array CPE or UE 120) may be achieved at a slot-level timeframe (e.g., approximately a 0.1 milliseconds (ms)) or a symbol-level timeframe (e.g., approximately 0.01 ms). On the other hand, a mechanical positioning beam switch (e.g., a beam switch associated with a parabolic reflector CPE or a similar CPE) may take longer than an electronic beam switch, such as approximately 100 ms. Accordingly, switching between beams at a parabolic reflector CPE or a similar CPE may be too slow to comply with upper layer timelines for mobility, among other examples. In such examples, a CPE (e.g., a parabolic reflector CPE) and a network node 110 may ultimately communicate with a less than optimal beam pair, resulting in degraded communication channels, high latency, low throughput, and a high incidence of communication errors, thus leading to high computing, power, and network resource consumption for correcting communication errors.

Some techniques and aspects described herein enable determination of optimal CPE position or beam settings (e.g., a CPE position or beam setting associated with a highest signal strength) for a CPE attempting initial acquisition, such as a parabolic reflector CPE performing an initial acquisition operation. In some aspects, a CPE may perform a “fingerprinting” operation or a similar operation in which the CPE measures one or more channels using multiple candidate CPE settings (e.g., multiple azimuth or elevation settings), resulting in multiple sets of measurement results. The CPE may store the multiple sets of a measurement results in a data structure (e.g., a fingerprinting database) that may be used during an initial acquisition operation. In some aspects, due to a smaller field of view of the CPE (e.g., relative to a phased array device) or because mechanical steering over a large angular coverage may be substantially slower than phased array beamforming, the CPE may perform the fingerprinting operation in a manner that is asynchronous to a protocol timeline, such as by disabling a data communication capability (e.g., an FR2 capability) of the CPE during the fingerprinting operation. In this way, during an initial acquisition operation, the CPE may identify, via the data structure (e.g., the fingerprinting database), a set of measurement results associated a highest signal-strength metric, and may use a corresponding CPE setting (e.g., azimuth or elevation setting) to attempt initial acquisition (e.g., for transmitting a message associated with an initial acquisition operation). As a result, the CPE and a network node may communicate with an optimal beam pair, resulting in improved communication channels, reduced latency, increased throughput, and a low incidence of communication errors, thus leading to a reduction in computing, power, and network resource consumption otherwise required for correcting communication errors.

As indicated above, FIG. 5 is provided as an example. Other examples may differ from what is described with regard to FIG. 5.

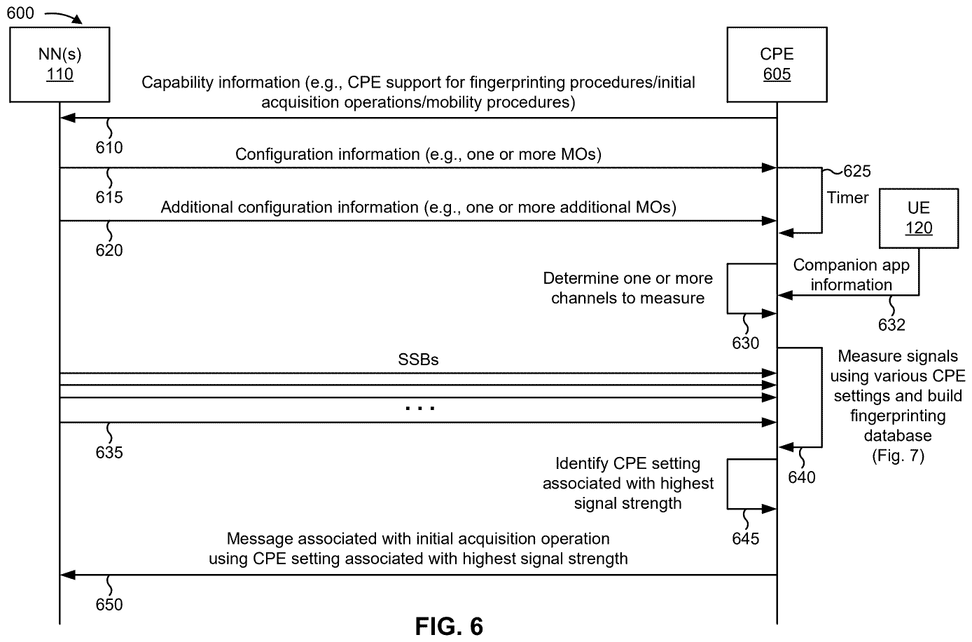

FIG. 6 is a diagram of an example 600 associated with initial acquisition operations for a CPE. As shown in FIG. 6, a network node 110 (e.g., a base station, a CU, a DU, or an RU) may communicate with a CPE 605 (e.g., CPE 502). In some aspects, the CPE 605 may be associated with a passive collimation technique, or the CPE 605 may be capable of beamforming using reflection or refraction of signals transmitted by an antenna panel or array, in a similar manner as described above in connection with the CPE 502 of FIG. 5. For example, in some aspects, the CPE 605 may be associated with one of a parabolic reflector CPE, a parabolic cylindrical reflector CPE, a parabolic cylindrical lens CPE, or a similar passive collimation CPE.

Additionally, or alternatively, the network node 110 and the CPE 605 may be part of a wireless network (e.g., the wireless communication network 100). The CPE 605 and the network node 110 may have established a wireless connection prior to operations shown in FIG. 6. For example, the CPE 605 may be capable of operating in a dual-connectivity mode associated with multiple RATs or multiple operating bands, and thus the CPE 605 and the network node 110 may have established a wireless connection via a certain RAT or operating band associated with the dual-connectivity mode prior to the operations shown in FIG. 6. In some aspects, the CPE 605 may be capable of operating in an Evolved Universal Mobile Telecommunications System Terrestrial Radio Access (E-UTRA)-NR dual connectivity (ENDC) mode, and the CPE 605 may have established a wireless communication via an anchor cell or RAT (e.g., a Long Term Evolution (LTE) cell) associated with the ENDC mode prior to the operations shown in FIG. 6. In some other aspects, the CPE 605 may be capable of operating in an NR dual connectivity (NRDC) mode, and the CPE 605 may have established a wireless connection via an anchor cell associated with a certain NR operating band (e.g., an FR1 cell) associated with the NRDC mode prior to the operations shown in FIG. 6.

In some other aspects, the CPE 605 may be associated with an operating band standalone mode, such as an FR2 standalone (FR2SA) mode or a similar standalone mode. In such aspects, the CPE 605 may have established a wireless connection with another wireless communication device (e.g., a wireless communication device other than the network node 110) prior to the operations shown in FIG. 6, such as via a WiFi capability of the CPE 605 or a Bluetooth capability of the CPE 605, among other examples. For example, as described in more detail below in connection with reference number 632, in some aspects the CPE 605 may receive information from a companion application at a UE 120 or a similar device, such as in aspects in which the CPE 605 is operating in an FR2SA mode. In such aspects, the CPE 605 may have established a wireless connection (e.g., via WiFi or Bluetooth, among other examples) with the UE 120 or the companion application at the UE 120 prior to the operations shown in FIG. 6.

In some aspects (e.g., aspects in which the CPE 605 is operating in a dual-connectivity mode), as shown by reference number 610, the CPE 605 may transmit (e.g., via an anchor cell or operating band associated with a dual-connectivity mode, among other examples), and the network node 110 may receive, capability information. The capability information may be included in a capability report. The CPE 605 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the CPE 605. The one or more parameters may be indicated via respective information elements (IEs) included in a capability report.

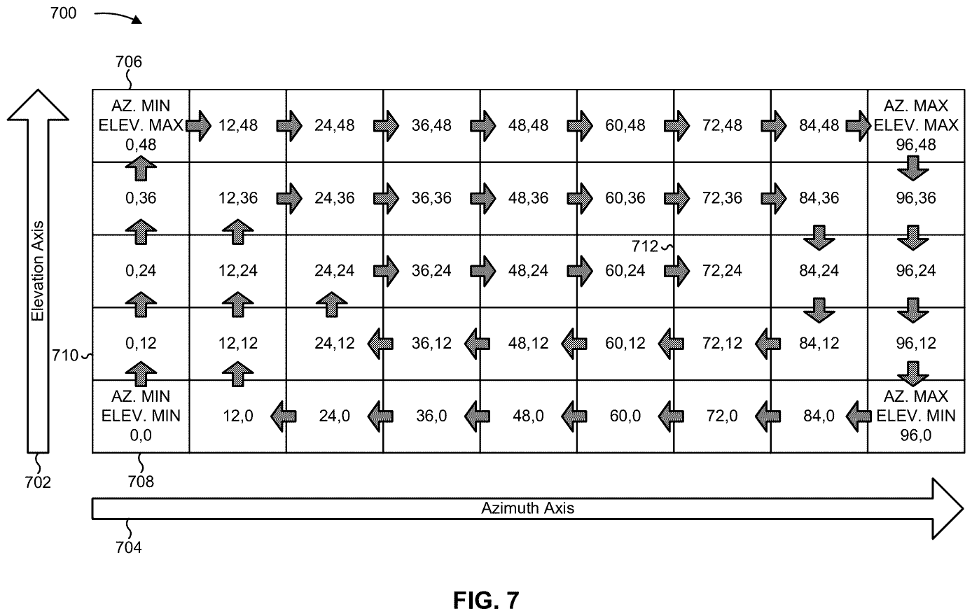

The capability information may indicate whether the CPE 605 supports a feature or one or more parameters related to the feature. For example, the capability information may indicate a capability or parameter for performing initial acquisition operations or mobility procedures. As another example, the capability information may indicate a capability or parameter for performing a fingerprinting operation (e.g., the fingerprinting operation described below in connection with reference number 640 and FIG. 7). One or more operations described herein may be based on capability information. For example, the CPE 605 may perform a communication in accordance with the capability information, or may receive configuration information that is in accordance with the capability information. In some aspects, the capability information may indicate CPE support for measuring one or more channels using multiple candidate

CPE settings (e.g., multiple azimuth or elevation settings), CPE support for storing multiple sets of measurement results in a data structure (e.g., CPE support for building a fingerprinting database), or CPE support for identifying (e.g., via the data structure) a set of measurement results associated with a highest signal-strength metric and transmitting a message associated with an initial acquisition operation using a CPE setting that is associated with the identified set of measurement results, among other examples.

As shown by reference numbers 615 and 620, the network node 110 may transmit, and the CPE 605 may receive, configuration information. In some aspects, the CPE 605 may receive the configuration information via one or more of system information signaling (e.g., a master information block (MIB) or a SIB, among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the CPE 605 or previously indicated by the network node 110 or other network device), or explicit configuration information for the CPE 605 to use to configure the CPE 605, among other examples.

In some examples, the configuration information may not be expressly signaled to the CPE 605. For example, in some aspects, the configuration information may at least partially be defined by a wireless communication standard, such as the 3GPP. In such examples, the network node 110 may not explicitly indicate such configuration information to the CPE 605. For example, the CPE 605 may optionally obtain at least a portion of the configuration information from a configuration stored by the CPE 605 (e.g., an original equipment manufacturer (OEM) configuration, sometimes referred to herein as a configuration file). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the CPE 605 is to perform a fingerprinting operation (e.g., the fingerprinting operation described below in connection with reference number 640 or FIG. 7) or that the CPE 605 is to build a fingerprinting database associated with the fingerprinting operation. Additionally, or alternatively, the configuration information may indicate one or more measurement objects (MOs) (e.g., a set of parameters that define which frequencies, bands, or cells that the CPE 605 should measure for an initial acquisition operation) associated with the CPE 605 performing a fingerprinting operation or building a fingerprinting database associated with the fingerprinting operation.

In some aspects, the CPE 605 may receive the configuration information via multiple communications received from the network node 110. More particularly, in aspects in which the configuration information indicates the one or more MOs, the CPE 605 the network node 110 may transmit, and the CPE 605 may receive, a first portion of the configuration information indicating a first subset of the one or more MOs (as indicated by reference number 615), a second portion of the configuration information indicating a second subset of the one or more MOs (as indicated by reference number 620), and so forth. In such aspects, the CPE 605 may initiate a timer (sometimes referred to herein a MO cache timer or MO_CACHE_TIMER) based at least in part on receiving the first portion of the configuration information (as indicated by reference number 625). The timer (e.g., MO_CACHE_TIMER) may be associated with a time period for receiving one or more additional portions of the configuration information indicating additional subsets of the one or more MOs. In such aspects, the CPE 605 may wait for the timer to expire prior to measuring any MOs.

More particularly, in aspects in which the CPE 605 is operating in an ENDC mode, one or more channels to be measured by the CPE 605 (e.g., specific FR2 absolute radio frequency channel numbers (ARFCNs), among other examples) may be configured by an anchor RAT (e.g., an anchor LTE cell) via a set of MOs, and the CPE 605 may report measurement results via a corresponding configured measurement report. In some aspects, the network node 110 may configure the CPE 605 for secondary cell (SCell) operation via a primary secondary cell (PSCell) add command, among other examples. In such aspects, after a first subset of NR MOs are configured (e.g., via the signaling shown in connection with reference number 615), the CPE 605 may wait for at least a time period associated with the timer (e.g., MO_CACHE_TIMER) to enable the network node 110 to configure additional MOs (e.g., via the signaling shown in connection with reference number 620). In the event that new NR MOs are received (e.g., via the signaling shown in connection with reference number 620, among other examples), the CPE 605 may trigger fingerprinting on the new MOs as well as the previously configured MOs to ensure that the CPE 605 has available scanning results on all available ARFCNs before attempting initial acquisition. Moreover, upon expiration of the timer (e.g., after MO_CACHE_TIMER expiry), the CPE 605 may initiate a fingerprinting operation (described in more detail below in connection with reference number 640 and FIG. 7).

In some other aspects, such as aspects in which the CPE 605 is operating in an NRDC mode, one or more channels to be measured by the CPE 605 (e.g., specific FR2 ARFCNs, among other examples) may be configured by an anchor cell associated with a certain operating band (e.g., an FR1 cell) via a set of MOs, and the CPE 605 may report measurement results via a corresponding configured measurement report. Additionally, or alternatively, in NRDC deployments, the network node 110 may configure the CPE 605 for SCell operation via a PSCell add command, among other examples. In such aspects, and in a similar manner as described above, after a first subset of NR MOs are configured (e.g., via the signaling shown in connection with reference number 615), the CPE 605 may wait for at least a time period associated with the timer (e.g., MO_CACHE_TIMER) to enable the network node 110 to configure additional MOs (e.g., via the signaling shown in connection with reference number 620). Upon expiration of the timer (e.g., after MO_CACHE_TIMER expiry), the CPE 605 may initiate a fingerprinting operation (described in more detail below in connection with reference number 640 and FIG. 7).

The CPE 605 may configure itself based at least in part on the configuration information. In some aspects, the CPE 605 may be configured to perform one or more operations described herein based at least in part on the configuration information.

In some other aspects, such as aspects in which the CPE 605 is operating in a standalone mode (e.g., an FR2SA mode), the CPE 605 may not receive any MOs from the network node 110 (e.g., the CPE 605 may not transmit the capability information described above in connection with reference number 610 or receive the configuration information described above in connection with reference numbers 615 an 620) because the CPE 605 may not have established a wireless connection with the network node 110 prior to the operations shown in FIG. 6. Put another way, in FR2SA deployments or similar modes, the CPE 605 may not have any prior knowledge of frequencies in use by the network node 110. In such aspects, without additional information, during a fingerprinting operation the CPE 605 may need to perform a full frequency scan, covering all sync-raster frequencies (e.g., sets of predefined frequency locations where SSBs can be transmitted by the network node 110) for all bands or channels supported by the CPE 605. Performing a full frequency scan, covering all sync-raster frequencies for all bands or channels supported by the CPE 605, may take a substantial amount of time, which in some aspects may be compounded by the reflector's narrow field of view or a need to search in multiple directions (e.g., using multiple CPE settings, such as multiple azimuth settings or elevation settings).

Accordingly, in some aspects, and as indicated by reference number 630, the CPE 605 may determine one or more channels to measure (which, in some aspects, may be associated with a subset of all sync-raster frequencies for all bands or channels supported by the CPE 605), such as for a purpose of reducing time and resources associated with performing a fingerprinting operation when the CPE 605 is operating in a standalone mode (e.g., FR2SA, among other examples). In some aspects, the CPE 605 may determine the one or more channels to measure based at least in part on information received from a companion application at a UE 120 that is associated with the CPE 605. In such aspects, the CPE 605 may receive, from the UE 120 (e.g., from a companion application operating at the UE 120), information associated with the one or more channels to measure (e.g., ARFCNs to be searched, among other examples). In some other aspects, the CPE 605 may determine the one or more channels to measure based at least in part on information received from a configuration file that is associated with the CPE 605 (e.g., a configuration file programmed by an OEM), among other examples.

Put another way, in some aspects (such as aspects in which the CPE 605 is associated with a parabolic reflector CPE or a similar CPE, or aspects in which the CPE 605 is associated with an FWA device, among other examples), the CPE 605 may limit a search space to a known set of ARFCNs, such as a known set of ARFCNs indicated by a companion UE 120 installation application (which may leverage the UE 120's geolocation to look up a set of candidate ARFCNs from an operator database), or by an operator pre-provisioned configuration file, among other examples. In some aspects, in absence of receiving any candidate ARFCNs (e.g., via a companion application at the UE 120 or a pre-provisioned configuration file, among other examples), the CPE 605 may wait in a current state of the CPE 605 until one or more candidate ARFCNs are received.

As indicated by reference number 635, the network node 110 may transmit, and the CPE 605 may receive, SSBs or similar signals in one or more channels associated with the fingerprinting operation. For example, the network node 110 may transmit SSBs in sync-raster frequencies associated with one or more MOs configured by the network node 110 (e.g., indicated via the configuration information described above in connection with reference numbers 615 and 620). Additionally, or alternatively, the network node 110 may transmit SSBs in sync-raster frequencies associated with one or more channels or ARFCNs indicated by a companion application at a UE 120 or a pre-provisioned configuration file, among other examples, as described above in connection with reference numbers 630 and 632.

As indicated by reference number 640, the CPE 605 may measure the one or more channels (e.g., the CPE 605 may measure SSBs transmitted in the one or more channels) using multiple candidate CPE settings, resulting in multiple sets of measurement results (e.g., RSRPs, signal-to-noise ratios (SNRs), RSSIs, RSRQs, or similar measurement results). In some aspects, each candidate CPE setting may be associated with a respective CPE elevation setting and a respective CPE azimuth setting. In that regard, the CPE 605 may measure, using a first elevation/azimuth combination, each channel (e.g., each ARFCN or sync-raster frequency) by cycling an RF component through each frequency, and recording the measurement results for each channel. The CPE 605 may then measure, using a second elevation/azimuth combination, each channel (e.g., each ARFCN or sync-raster frequency) by cycling an RF component through each frequency, and recording the measurement results for each channel, and so forth. Moreover, the CPE 605 may store the multiple sets of measurement results in a data structure (e.g., the fingerprinting database), such that the various measurement results may be used by the CPE 605 during an initial acquisition operation, which is described in more detail below in connection with reference numbers 645 and 650.

In some aspects, the CPE 605 may measure the one or more channels using the multiple candidate CPE settings with a data communication capability of the CPE 605 disabled. More particularly, as described above in connection with FIG. 5, in some aspects the CPE 605 use mechanical positioning to switch beams (e.g., by adjusting an elevation setting or azimuth setting), which may happen relatively slowly or which may happen too slow to comply with upper layer timelines for mobility, among other examples. For example, cycling through the various elevation and azimuth settings for each channel may take the CPE 605 several minutes to complete. Accordingly, the CPE 605 may disable a data communication capability, such as an FR2 capability of the CPE 605, in order to permit the perform the measurements in a manner that is asynchronous to the protocol timeline. Additional aspects of measuring the one or more channels using the various candidate CPE settings and building a corresponding data structure (e.g., fingerprinting database) are described in more detail below in connection with FIG. 7.

As indicated by reference number 645, the CPE 605 may identify, via the data structure (e.g., the fingerprinting database storing the various measurement results described above in connection with reference number 640), a set of measurement results (and thus a corresponding CPE setting) that is associated a highest signal-strength metric. Put another way, when the CPE 605 is to perform an initial acquisition operation, the CPE 605 may search the data structure to determine a CPE setting in which a signal strength for a given channel was the highest so that the CPE setting (e.g., elevation and azimuth combination) may be used during the initial acquisition operation. For example, the CPE 605 may identify a certain channel (e.g., MO) to be used to perform an initial acquisition operation or may identify a certain CPE setting (e.g., elevation and azimuth combination) to be used for a channel when performing the initial acquisition operation based at least in part on a highest RSRP, SNR, RSSI, RSRQ, or similar signal-strength metric stored in the data structure. Put another way, upon completion of the fingerprinting operation, the CPE 605 may move to the best position as determined from the fingerprinting database, prior to entering the initial acquisition state.

As indicated by reference number 650, the CPE 605 may transmit, and the network node 110 may receive, a message associated with an initial acquisition operation by using a candidate CPE setting (e.g., elevation and azimuth combination) that is associated with the set of measurement results identified as having the highest signal-strength metric. In some aspects, such as aspects in which the CPE 605 is operating in a dual-connectivity mode (e.g., ENDC or NRDC), the CPE 605 may trigger a radio link failure (RLF) on one of a RAT (e.g., an anchor RAT, such as LTE in ENDC) or an operating band (e.g., an anchor band, such as FR1 in NRDC) prior to transmitting the message. More particularly, the CPE 605 may trigger an RLF on LTE or FR1 in order for the network node 110 to reinstate FR2 MOs, among other examples, and the CPE 605 may thus move into the initial acquisition state or transmit the message associated with an initial acquisition operation using a selected CPE setting based at least in part on triggering the RLF. In some other aspects, such as in aspects in which the CPE 605 is operating in a standalone mode (e.g., FR2SA), because there may be no prerequisite of a network configured MO, the CPE 605 may simply enter the initial acquisition state on completion of the fingerprinting operation (e.g., transmitting the message associated with the initial acquisition operation using the selected candidate CPE setting may include transmitting the message based at least in part on completion of measuring the one or more channels).

In some aspects, the CPE 605 may transmit multiple messages associated with the initial acquisition operation, such as in aspects in which initial acquisition using the best CPE setting (e.g., the CPE setting associated with the highest signal strength metric) fails. That is, if initial acquisition on the best CPE setting fails, the CPE 605 may move to the next best CPE setting as per the fingerprinting database, and the CPE 605 may again initiate an RLF (e.g., an LTE RLF or FR1 RLF, among other examples) in order to trigger the network node 110 to reconfigure MOs, among other examples. Accordingly, in some aspects, the CPE 605 may detect that the initial acquisition operation using a first candidate CPE setting has failed, the CPE 605 may identify another set of measurement results that is associated a next highest signal-strength metric, and the CPE 605 may transmit another message associated with the initial acquisition operation using a second candidate CPE setting that is associated with the second set of measurement results.

This process may continue until either a connection with the network node 110 is successfully established, resulting in the CPE 605 entering a connected mode, or all nodes in the fingerprinting database are exhausted, at which point the CPE 605 may reenter fingerprinting (e.g., may again perform the operations described above in connection with reference numbers 635 and 640). That is, in some aspects, the CPE 605 may detect that the initial acquisition operation failed using each candidate CPE setting, and the CPE 605 may remeasure the one or more channels using the multiple candidate CPE settings. Additional aspects associated with a fingerprinting operation performed by the CPE 605 are described in more detail below in connection with FIG. 7.

As indicated above, FIG. 6 is provided as an example. Other examples may differ from what is described with respect to FIG. 6.

FIG. 7 is a diagram illustrating an example 700 associated with a fingerprinting operation for a CPE. The example 700 may include communication between the network node 110, the CPE 605, or the UE 120, as described above in connection with FIG. 6.

As described above in connection with reference numbers 635 and 640, a CPE 605 may perform a fingerprinting operation, such as a for a purpose of populating a fingerprinting database used during an initial acquisition operation associated with the CPE 605. “Fingerprinting” refers to the process of creating a spatial coverage map (e.g., database) of various channel clusters by the CPE 605, in which the CPE 605 may track viable positions (e.g., CPE settings) on which a signal is received. The CPE 605 may store fingerprinting results (e.g., measurements results) in a data structure (e.g., a fingerprinting database), which may include per-position information (e.g., RSRP/SNR, cell index, SSB index, or ARFCN, among other examples) that satisfies certain thresholds, such as an event B1 threshold for ENDC (which refers to a neighboring cell becoming available, among other examples), among other examples. The fingerprinting database may then be used to determine the best position to attempt initial acquisition, in a similar manner as described above in connection with FIG. 6.

As shown in FIG. 7, the CPE 605 (more particularly, the reflector or antenna panel of the CPE 605) may be associated with an elevation axis 702 and an azimuth axis 704, corresponding to an elevation setting of the CPE 605 and an azimuth setting of the CPE 605, respectively. In the example 700, the CPE 605 may be capable of being set to an elevation setting of 0-48 degrees, and the CPE 605 may be capable of being set to an azimuth setting of 0-96 degrees. In some other aspects, the CPE 605 may be capable of being set to different ranges without departing from the scope of the disclosure. Moreover, in the example 700, the CPE 605 may adjust an elevation setting or an azimuth setting at a 12-degree granularity. In some other aspects, the CPE 605 may adjust an elevation setting or azimuth setting using a different granularity without departing from the scope of the disclosure.

During a fingerprinting operation, the CPE 605 may move to each position shown in a fingerprinting table 706, and may perform various measurements on one or more channels at that position. For example, the fingerprinting operation may begin with the CPE 605 using setting associated with a first cell 708 in the fingerprinting table 706, which corresponds to a minimum elevation setting (e.g., 0 degrees) and a minimum azimuth setting (e.g., 0 degrees) (shown in the first cell 708 as “0,0”). The CPE 605, while in the first position (e.g., 0,0), may tune an RF component associated with the CPE 605 to each channel (e.g., ARFCN) to be measured (which may be configured MOs, ARFCNs indicated by a companion application, ARFCNs indicated by a pre-provisioned configuration file, or the like, as described above in connection with FIG. 6), the CPE 605 may run a cell search operation to receive and measure one or more SSBs associated with that channel, and the CPE 605 may store the various measurement results in the fingerprinting database.

Once all channels have been measured at the first position (e.g., 0,0), the CPE 605 may reposition by using a setting associated with a second cell 710 in the fingerprinting table 706 (as schematically indicated by the thick arrow extending from the first cell 708 to the second cell 710), which corresponds to an elevation setting of 12 degrees and the minimum azimuth setting (e.g., 0 degrees) (shown in the second cell 710 as “0,12”). The CPE 605, while in the second position (e.g., 0,12), may again tune the RF component to each channel (e.g., ARFCN) to be measured, run a cell search operation to receive and measure one or more SSBs associated with that channel, and store the measurement results in the fingerprinting database. The CPE 605 may proceed in a like manner for each setting in each cell of the fingerprinting table 706, such as by following the thick arrows through the fingerprinting table until the CPE 605 completes measurements using settings associated with a last cell 712 (corresponding to an elevation setting of 24 degrees and an azimuth setting of 72 degrees in this example).

As described above in connection with FIG. 6, while performing the fingerprinting operation, the CPE 605 may disable a data communication capability of the CPE 605 (e.g., during fingerprinting, all FR2 capability of the CPE 605 may be disabled, among other examples). In this way, due to the smaller field of view of the CPE 605 (e.g., relative to a phased array device) or that mechanical steering over a large angular coverage is substantially slower than phased array beamforming, the fingerprinting may be performed in a manner that is asynchronous to the protocol timeline, as described above in connection with FIG. 6.

Based at least in part on the CPE 605 using a fingerprinting operation to select a CPE setting for communicating with the network node 110 during an initial acquisition operation, the CPE 605 or the network node 110 may conserve computing, power, network, or communication resources that may have otherwise been consumed using initial acquisition operations that conform to a protocol timeline, among other examples. For example, based at least in part on the CPE 605 using a fingerprinting operation to select a CPE setting for communicating with the network node 110 during an initial acquisition operation, the CPE 605 and the network node 110 may communicate with an optimal beam pair and thus a reduced error rate, which may conserve computing, power, network, or communication resources that may have otherwise been consumed to detect or correct communication errors.

As indicated above, FIG. 7 is provided as an example. Other examples may differ from what is described with respect to FIG. 7.

FIG. 8 is a diagram illustrating an example process 800 performed, for example, at a CPE or an apparatus of a CPE. Example process 800 is an example where the apparatus or the CPE (e.g., CPE 605) performs operations associated with initial acquisition procedures.

As shown in FIG. 8, in some aspects, process 800 may include measuring one or more channels using multiple candidate CPE settings, resulting in multiple sets of measurement results (block 810). For example, the CPE (e.g., using communication manager 906, depicted in FIG. 9) may measure one or more channels using multiple candidate CPE settings, resulting in multiple sets of measurement results, as described above.

As further shown in FIG. 8, in some aspects, process 800 may include storing the multiple sets of measurement results in a data structure (block 820). For example, the CPE (e.g., using communication manager 906, depicted in FIG. 9) may store the multiple sets of measurement results in a data structure, as described above.

As further shown in FIG. 8, in some aspects, process 800 may include identifying, via the data structure, a first set of measurement results, of the multiple sets of measurement results, that is associated a highest signal-strength metric (block 830). For example, the CPE (e.g., using communication manager 906, depicted in FIG. 9) may identify, via the data structure, a first set of measurement results, of the multiple sets of measurement results, that is associated a highest signal-strength metric, as described above.

As further shown in FIG. 8, in some aspects, process 800 may include transmitting, based at least in part on identifying the first set of measurement results, a message associated with an initial acquisition operation using a first candidate CPE setting, of the multiple candidate CPE settings, that is associated with the first set of measurement results (block 840). For example, the CPE (e.g., using transmission component 904 or communication manager 906, depicted in FIG. 9) may transmit, based at least in part on identifying the first set of measurement results, a message associated with an initial acquisition operation using a first candidate CPE setting, of the multiple candidate CPE settings, that is associated with the first set of measurement results, as described above.

Process 800 may include additional aspects, such as any single aspect or any combination of aspects described below or in connection with one or more other processes described elsewhere herein.

In a first aspect, the CPE is associated with one of a parabolic reflector CPE, a parabolic cylindrical reflector CPE, or a parabolic cylindrical lens CPE.

In a second aspect, alone or in combination with the first aspect, each candidate CPE setting, of the multiple candidate CPE settings, is associated with a respective CPE elevation setting and a respective CPE azimuth setting.

In a third aspect, alone or in combination with one or more of the first and second aspects, measuring the one or more channels using the multiple candidate CPE settings includes measuring the one or more channels with a data communication capability of the CPE disabled.

In a fourth aspect, alone or in combination with one or more of the first through third aspects, the CPE is associated with a dual-connectivity mode, the one or more channels are associated with one of a first RAT associated with the dual-connectivity mode or a first operating band associated with the dual-connectivity mode, and the method further comprises receiving, via one of a second RAT associated with the dual-connectivity mode or a second operating band associated with the dual-connectivity mode, configuration information indicating one or more MOs associated with the one or more channels.

In a fifth aspect, alone or in combination with one or more of the first through fourth aspects, receiving the configuration information includes receiving a first portion of the configuration information indicating a first subset of the one or more MOs, and process 800 includes initiating a timer based at least in part on receiving the first portion of the configuration information, wherein the timer is associated with a time period for receiving one or more additional portions of the configuration information indicating additional subsets of the one or more MOs, and wherein measuring the one or more channels using the multiple candidate CPE settings is based at least in part on the timer expiring.

In a sixth aspect, alone or in combination with one or more of the first through fifth aspects, process 800 includes triggering an RLF on one of the second RAT or the second operating band, wherein transmitting the message associated the initial acquisition operation includes transmitting the message based at least in part on triggering the RLF.

In a seventh aspect, alone or in combination with one or more of the first through sixth aspects, process 800 includes detecting that the initial acquisition operation using the first candidate CPE setting has failed, identifying a second set of measurement results, of the multiple sets of measurement results, that is associated a next highest signal-strength metric, and transmitting, based at least in part on identifying the second set of measurement results, another message associated with the initial acquisition operation using a second candidate CPE setting, of the multiple candidate CPE settings, that is associated with the second set of measurement results.

In an eighth aspect, alone or in combination with one or more of the first through seventh aspects, the CPE is associated with an operating band standalone mode, and process 800 includes determining the one or more channels based at least in part on one of information received from an application at a UE that is associated with the CPE, or information received from a configuration file that is associated with the CPE.

In a ninth aspect, alone or in combination with one or more of the first through eighth aspects, transmitting the message associated with the initial acquisition operation using the first candidate CPE setting includes transmitting the message based at least in part on completion of measuring the one or more channels.

In a tenth aspect, alone or in combination with one or more of the first through ninth aspects, process 800 includes detecting that the initial acquisition operation failed using each candidate CPE setting, of the multiple candidate CPE settings, and remeasuring the one or more channels using the multiple candidate CPE settings based at least in part detecting that the initial acquisition operation failed using each candidate CPE setting.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a CPE, or a CPE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the CPE.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8. In some aspects, the apparatus 900 or one or more components shown in FIG. 9 may include one or more components of the UE 120 described in connection with FIG. 1 or the CPE 502 described in connection with FIG. 5. Additionally, or alternatively, one or more components shown in FIG. 9 may be implemented within one or more components described in connection with FIG. 1 or FIG. 5. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE 120 described above in connection with FIG. 1 or the CPE 502 described above in connection with FIG. 5, such as a radio, one or more RF chains, one or more transceivers, or one or more modems, each of which may in turn be coupled with one or more antennas of the UE 120 or CPE 502.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE 120 described above in connection with FIG. 1 or the CPE 502 described above in connection with FIG. 5, such as a radio, one or more RF chains, one or more transceivers, or one or more modems, each of which may in turn be coupled with one or more antennas of the UE 120 described above in connection with FIG. 1 or the CPE 502 described above in connection with FIG. 5. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The communication manager 906 may measure one or more channels using multiple candidate CPE settings, resulting in multiple sets of measurement results. The communication manager 906 may store the multiple sets of measurement results in a data structure. The communication manager 906 may identify, via the data structure, a first set of measurement results, of the multiple sets of measurement results, that is associated a highest signal-strength metric. The transmission component 904 may transmit, based at least in part on identifying the first set of measurement results, a message associated with an initial acquisition operation using a first candidate CPE setting, of the multiple candidate CPE settings, that is associated with the first set of measurement results.

The communication manager 906 may trigger an RLF on one of the second RAT or the second operating band wherein transmitting the message associated the initial acquisition operation includes transmitting the message based at least in part on triggering the RLF.

The communication manager 906 may detect that the initial acquisition operation using the first candidate CPE setting has failed.

The communication manager 906 may identify a second set of measurement results, of the multiple sets of measurement results, that is associated a next highest signal-strength metric.

The transmission component 904 may transmit, based at least in part on identifying the second set of measurement results, another message associated with the initial acquisition operation using a second candidate CPE setting, of the multiple candidate CPE settings, that is associated with the second set of measurement results.

The communication manager 906 may detect that the initial acquisition operation failed using each candidate CPE setting, of the multiple candidate CPE settings.

The communication manager 906 may remeasure the one or more channels using the multiple candidate CPE settings based at least in part detecting that the initial acquisition operation failed using each candidate CPE setting.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

### Aspect 1:

A method of wireless communication performed by a customer premises equipment (CPE), comprising: measuring one or more channels using multiple candidate CPE settings, resulting in multiple sets of measurement results; storing the multiple sets of measurement results in a data structure; identifying, via the data structure, a first set of measurement results, of the multiple sets of measurement results, that is associated a highest signal-strength metric; and transmitting, based at least in part on identifying the first set of measurement results, a message associated with an initial acquisition operation using a first candidate CPE setting, of the multiple candidate CPE settings, that is associated with the first set of measurement results.

### Aspect 2:

The method of Aspect 1, wherein the CPE is associated with one of a parabolic reflector CPE, a parabolic cylindrical reflector CPE, or a parabolic cylindrical lens CPE.

### Aspect 3:

The method of any of Aspects 1-2, wherein each candidate CPE setting, of the multiple candidate CPE settings, is associated with a respective CPE elevation setting and a respective CPE azimuth setting.

### Aspect 4:

The method of any of Aspects 1-3, wherein measuring the one or more channels using the multiple candidate CPE settings includes measuring the one or more channels with a data communication capability of the CPE disabled.

### Aspect 5:

The method of any of Aspects 1-4, wherein the CPE is associated with a dual-connectivity mode, wherein the one or more channels are associated with one of a first radio access technology (RAT) associated with the dual-connectivity mode or a first operating band associated with the dual-connectivity mode, and wherein the method further comprises receiving, via one of a second RAT associated with the dual-connectivity mode or a second operating band associated with the dual-connectivity mode, configuration information indicating one or more measurements objects (MOs) associated with the one or more channels.

### Aspect 6:

The method of Aspect 5, wherein receiving the configuration information includes receiving a first portion of the configuration information indicating a first subset of the one or more MOs, wherein the method further comprises initiating a timer based at least in part on receiving the first portion of the configuration information, wherein the timer is associated with a time period for receiving one or more additional portions of the configuration information indicating additional subsets of the one or more MOs, and wherein measuring the one or more channels using the multiple candidate CPE settings is based at least in part on the timer expiring.

### Aspect 7:

The method of Aspect 5, further comprising triggering a radio link failure (RLF) on one of the second RAT or the second operating band, wherein transmitting the message associated the initial acquisition operation includes transmitting the message based at least in part on triggering the RLF.

### Aspect 8:

The method of any of Aspects 1-7, further comprising: detecting that the initial acquisition operation using the first candidate CPE setting has failed; identifying a second set of measurement results, of the multiple sets of measurement results, that is associated a next highest signal-strength metric; and transmitting, based at least in part on identifying the second set of measurement results, another message associated with the initial acquisition operation using a second candidate CPE setting, of the multiple candidate CPE settings, that is associated with the second set of measurement results.

### Aspect 9:

The method of any of Aspects 1-4 or 8, wherein the CPE is associated with an operating band standalone mode, and wherein the method further comprises determining the one or more channels based at least in part on one of: information received from an application at a user equipment that is associated with the CPE, or information received from a configuration file that is associated with the CPE.

### Aspect 10:

The method of any of Aspects 1-9, wherein transmitting the message associated with the initial acquisition operation using the first candidate CPE setting includes transmitting the message based at least in part on completion of measuring the one or more channels.

### Aspect 11:

The method of any of Aspects 1-10, further comprising: detecting that the initial acquisition operation failed using each candidate CPE setting, of the multiple candidate CPE settings; and remeasuring the one or more channels using the multiple candidate CPE settings based at least in part detecting that the initial acquisition operation failed using each candidate CPE setting.

### Aspect 12:

An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

### Aspect 13:

An apparatus for wireless communication at a device, the apparatus comprising one or more memories and one or more processors coupled to the one or more memories, the one or more processors configured to cause the device to perform the method of one or more of Aspects 1-11.

### Aspect 14:

An apparatus for wireless communication, the apparatus comprising at least one means for performing the method of one or more of Aspects 1-11.

### Aspect 15:

A non-transitory computer-readable medium storing code for wireless communication, the code comprising instructions executable by one or more processors to perform the method of one or more of Aspects 1-11.

### Aspect 16:

A non-transitory computer-readable medium storing a set of instructions for wireless communication, the set of instructions comprising one or more instructions that, when executed by one or more processors of a device, cause the device to perform the method of one or more of Aspects 1-11.

### Aspect 17:

A device for wireless communication, the device comprising a processing system that includes one or more processors and one or more memories coupled with the one or more processors, the processing system configured to cause the device to perform the method of one or more of Aspects 1-11.

### Aspect 18:

An apparatus for wireless communication at a device, the apparatus comprising one or more memories and one or more processors coupled to the one or more memories, the one or more processors individually or collectively configured to cause the device to perform the method of one or more of Aspects 1-11.

### Aspect 19:

A device comprising a processing system that includes one or more processors and one or more code-storing memories coupled with the one or more processors, the processing system configured to cause the device to perform the method of one or more of Aspects 1-11.

### Aspect 20:

A device comprising a processing system that includes processor circuitry and code-storing memory circuitry, the processing system configured to cause the device to perform the method of one or more of Aspects 1-11.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A customer premises equipment (CPE), comprising:
a processing system that includes one or more processors and one or more code-storing memories coupled with the one or more processors, the processing system configured to cause the CPE to:
measure one or more channels using multiple candidate CPE settings, resulting in multiple sets of measurement results;
store the multiple sets of measurement results in a data structure;
identify, via the data structure, a first set of measurement results, of the multiple sets of measurement results, that is associated a highest signal-strength metric; and
transmit, based at least in part on the identification of the first set of measurement results, a message associated with an initial acquisition operation using a first candidate CPE setting, of the multiple candidate CPE settings, that is associated with the first set of measurement results.

2. The CPE of claim 1, wherein the CPE is associated with one of a parabolic reflector CPE, a parabolic cylindrical reflector CPE, or a parabolic cylindrical lens CPE.

3. The CPE of claim 1, wherein each candidate CPE setting, of the multiple candidate CPE settings, is associated with a respective CPE elevation setting and a respective CPE azimuth setting.

4. The CPE of claim 1, wherein the processing system, to cause the CPE to measure the one or more channels using the multiple candidate CPE settings, is configured to cause the CPE to measure the one or more channels with a data communication capability of the CPE disabled.

5. The CPE of claim 1, wherein the CPE is associated with a dual-connectivity mode,
wherein the one or more channels are associated with one of a first radio access technology (RAT) associated with the dual-connectivity mode or a first operating band associated with the dual-connectivity mode, and
wherein the processing system is further configured to cause the CPE to receive, via one of a second RAT associated with the dual-connectivity mode or a second operating band associated with the dual-connectivity mode, configuration information indicating one or more measurements objects (MOs) associated with the one or more channels.

6. The CPE of claim 5, wherein the processing system, to cause the CPE to receive the configuration information, is configured to cause the CPE to receive a first portion of the configuration information indicating a first subset of the one or more MOs, wherein the processing system is further configured to cause the CPE to initiate a timer based at least in part on the reception of the first portion of the configuration information,
wherein the timer is associated with a time period for receiving one or more additional portions of the configuration information indicating additional subsets of the one or more MOs, and
wherein the processing system, to cause the CPE to measure the one or more channels using the multiple candidate CPE settings, is configured to cause the CPE to measure the one or more channels based at least in part on the timer expiring.

7. The CPE of claim 5, wherein the processing system is further configured to cause the CPE to trigger a radio link failure (RLF) on one of the second RAT or the second operating band, and
wherein the processing system, to cause the CPE to transmit the message associated the initial acquisition operation, is configured to cause the CPE to transmit the message based at least in part on triggering the RLF.

8. The CPE of claim 1, wherein the processing system is configured to cause the CPE to:
detect that the initial acquisition operation using the first candidate CPE setting has failed;
identify a second set of measurement results, of the multiple sets of measurement results, that is associated a next highest signal-strength metric; and
transmit, based at least in part on identifying the second set of measurement results, another message associated with the initial acquisition operation using a second candidate CPE setting, of the multiple candidate CPE settings, that is associated with the second set of measurement results.

9. The CPE of claim 1, wherein the CPE is associated with an operating band standalone mode, and
wherein the processing system is further configured to cause the CPE to determine the one or more channels based at least in part on one of:
information received from an application at a user equipment that is associated with the CPE, or
information received from a configuration file that is associated with the CPE.

10. The CPE of claim 1, wherein the processing system, to cause the CPE to transmit the message associated with the initial acquisition operation using the first candidate CPE setting, is configured to cause the CPE to transmit the message based at least in part on completion of a measurement of the one or more channels.

11. The CPE of claim 1, wherein the processing system is configured to cause the CPE to:
detect that the initial acquisition operation failed using each candidate CPE setting, of the multiple candidate CPE settings; and
remeasure the one or more channels using the multiple candidate CPE settings based at least in part detecting that the initial acquisition operation failed using each candidate CPE setting.

12. A method of wireless communication performed by a customer premises equipment (CPE), comprising:
measuring one or more channels using multiple candidate CPE settings, resulting in multiple sets of measurement results;
storing the multiple sets of measurement results in a data structure;
identifying, via the data structure, a first set of measurement results, of the multiple sets of measurement results, that is associated a highest signal-strength metric; and
transmitting, based at least in part on identifying the first set of measurement results, a message associated with an initial acquisition operation using a first candidate CPE setting, of the multiple candidate CPE settings, that is associated with the first set of measurement results.

13. The method of claim 12, wherein each candidate CPE setting, of the multiple candidate CPE settings, is associated with a respective CPE elevation setting and a respective CPE azimuth setting.

14. The method of claim 12, wherein measuring the one or more channels using the multiple candidate CPE settings includes measuring the one or more channels with a data communication capability of the CPE disabled.

15. The method of claim 12, wherein the CPE is associated with a dual-connectivity mode,
wherein the one or more channels are associated with one of a first radio access technology (RAT) associated with the dual-connectivity mode or a first operating band associated with the dual-connectivity mode, and
wherein the method further comprises receiving, via one of a second RAT associated with the dual-connectivity mode or a second operating band associated with the dual-connectivity mode, configuration information indicating one or more measurements objects (MOs) associated with the one or more channels.

16. The method of claim 15, wherein receiving the configuration information includes receiving a first portion of the configuration information indicating a first subset of the one or more MOs,
wherein the method further comprises initiating a timer based at least in part on receiving the first portion of the configuration information,
wherein the timer is associated with a time period for receiving one or more additional portions of the configuration information indicating additional subsets of the one or more MOs, and
wherein measuring the one or more channels using the multiple candidate CPE settings is based at least in part on the timer expiring.

17. The method of claim 15, further comprising triggering a radio link failure (RLF) on one of the second RAT or the second operating band,
wherein transmitting the message associated the initial acquisition operation includes transmitting the message based at least in part on triggering the RLF.

18. The method of claim 12, wherein the CPE is associated with an operating band standalone mode, and
wherein the method further comprises determining the one or more channels based at least in part on one of:
information received from an application at a user equipment that is associated with the CPE, or
information received from a configuration file that is associated with the CPE.

19. A non-transitory computer-readable medium storing a set of instructions for wireless communication, the set of instructions comprising:
one or more instructions that, when executed by one or more processors of a customer premises equipment (CPE), cause the CPE to:
measure one or more channels using multiple candidate CPE settings, resulting in multiple sets of measurement results;
store the multiple sets of measurement results in a data structure;
identify, via the data structure, a first set of measurement results, of the multiple sets of measurement results, that is associated a highest signal-strength metric; and
transmit, based at least in part on identifying the first set of measurement results, a message associated with an initial acquisition operation using a first candidate CPE setting, of the multiple candidate CPE settings, that is associated with the first set of measurement results.

20. The non-transitory computer-readable medium of claim 19, wherein each candidate CPE setting, of the multiple candidate CPE settings, is associated with a respective CPE elevation setting and a respective CPE azimuth setting.
